(19) United States
(12) Patent Application Publication
(10) Pub. No.: US 2008/0263545 A1
(43) Pub. Date: Oct. 23, 2008

(54) SIGNAL DELIVERY TO A PROCESS IN A PROCESS GROUP

(75) Inventors: Weidong Cai, Sunnyvale, CA (US); William Pohl, Morgan Hill, CA (US); Edward J. Sharpe, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/739,087

(22) Filed: Apr. 23, 2007

(51) Int. Cl. G06F 9/46

(52) U.S. Cl. 718/100

(57) ABSTRACT

A method of handling a signal for delivery to a process in a process group along with an apparatus and computer-readable medium storing instructions therefore are described. The method comprises obtaining a lock on a portion of a process group management structure and storing a signal to the process group management structure, wherein the signal is to be delivered to one or more processes of a process group, wherein an operating system manages the process group management structure. The method further comprises transmitting a wakeup signal to a signal daemon and releasing the obtained lock. A method of delivering a signal to a process in a process group is also described. The method comprises obtaining a signal from a process group management structure, obtaining a lock on a process list, transmitting the signal to a process specified in the process list; and releasing the lock on the process list.

### BACKGROUND

An operating system in a computer comprises a set of executable instructions which, when executed by a computer processor, manages execution of one or more processes by the processor. The computer system may comprise more than one processor, e.g., a multiprocessor computer, and the operating system may concurrently manage execution of the processes. The processes may be organized into process groups. A process group comprises several processes which, in at least some embodiments, are associated with a related task. Several processes of the process group can, but may not be required to, comprise the same group leader process. Child and/or descendant processes may span a plurality of groups, i.e., a process group may comprise child processes of a plurality of parent processes. The operating system comprises a data structure for management of the processes and process groups. The data structure may comprise a process list that identifies the processes within a process group.

Multithreaded computer programs and/or multiprocessor computer systems have multiple threads and/or processors that share use of a number of resources. Access coordination and/or synchronization functionality of the operating system organize access by a plurality of the processors to one or more of the shared resources. A tool for access coordination and/or synchronization comprises a lock, for example, a spinlock. A spinlock is a type of lock in which a process requesting a lock for a particular resource waits until the resource lock is available prior to proceeding with execution, i.e., the process “spins” waiting for access to the resource lock.

A process may communicate with other processes by transmitting signals. When a process needs to send a signal to the processes of a process group, the process iterates over the process list and transmits a signal to the processes in the process group. Where multiple processes are executed concurrently, the operating system employs locks such as spinlocks to maintain data integrity, i.e., prevent concurrent access to the same data by differing processes. The process obtains a spinlock for the process list before the process iterates over the process list to transmit a signal to the processes in the process group. The spinlock ensures that the process list does not change while the process transmits the signal to the processes.

### DESCRIPTION OF THE DRAWINGS

One or more embodiments is illustrated by way of example, and not by limitation, in the figures of the accompanying drawings, wherein elements having the same reference numeral designations represent like elements throughout and wherein:

FIG. 1 is a high-level block diagram of an apparatus in conjunction with which an embodiment may be operated to advantage;

FIG. 2 is a high-level process flow diagram of signal setting according to an embodiment;

FIG. 3 is a high-level process flow diagram of signal transmission according to an embodiment; and

FIG. 4 is a high-level process flow diagram of signal transmission according to another embodiment.

### DETAILED DESCRIPTION

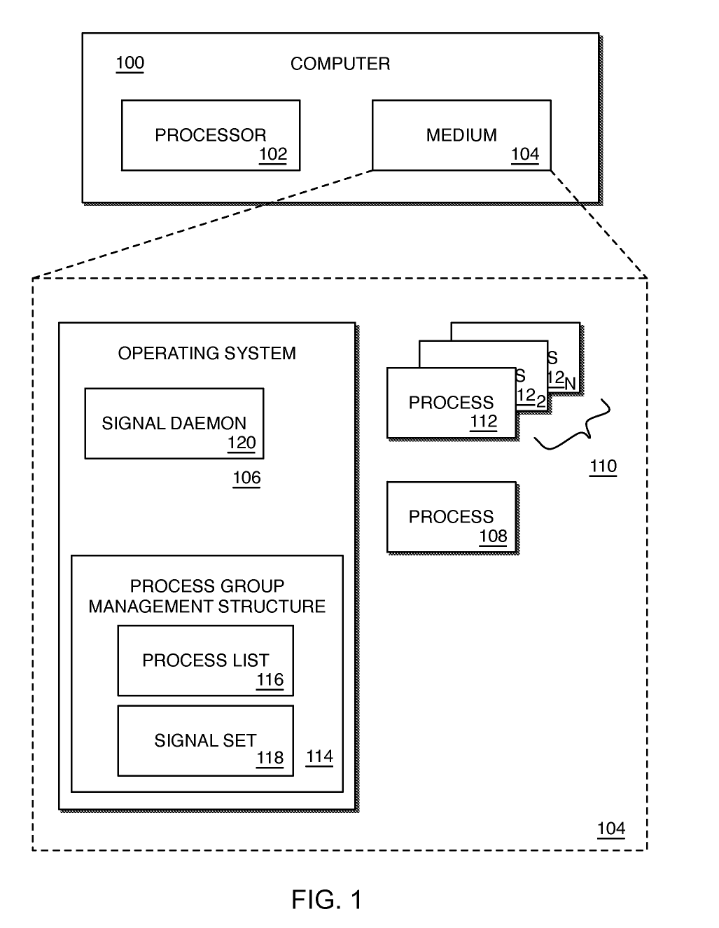

FIG. 1 depicts an apparatus, i.e., a computer system 100, comprising a processor 102 communicatively coupled, e.g., via a bus or other connection mechanism, with a storage medium 104. Storage medium 104 comprises a computer-readable signal bearing media, e.g., one or more recordable storage media. In at least some embodiments, storage medium 104 comprises a memory, e.g., analog and/or digital memory device such as random access memory, read-only memory, etc., and/or other storage devices such as a hard drive, compact or digital versatile disc drive, etc. In at least some embodiments, computer system 100 comprises two or more processors, e.g., a multiprocessor computer system.

In at least some embodiments, multiprocessor computer systems may comprise two, four, eight, sixteen, thirty-two, sixty-four and/or other combinations of processors. Two or more of the processors in an example may contend on a same memory address space of storage medium 104 in computer system 100, such as when sharing access to resources. An access coordination mechanism (access coordinator) such as a lock, e.g., a blocking or non-blocking lock, enables the protection, coordination, and/or synchronization of access to a shared resource. Exemplary locks that involve a processor spinning and/or waiting comprise one or more of spinlocks, read/write spinlocks, read/write blocking locks, adaptive locks, mutexes (mutual exclusion negotiators), condition variables, and semaphores.

Storage medium 104 comprises one or more sets of instructions which, when executed by processor 102, cause the processor to perform one or more operations according to at least an embodiment. Storage medium 104 comprises an operating system 106, a first process 108, and a set of processes 110 which comprises additional processes 112_{(1-N)}.

In at least some embodiments, operating system 106 comprises an operating system for computer system 100 such as HP-UX available from HEWLETT-PACKARD COMPANY of Palo Alto, Calif., SOLARIS available from SUN MICROSYSTEMS, INC., of Santa Clara, Calif., AIX (IBM CORPORATION, White Plains, N.Y., WINDOWS available from MICROSOFT CORPORATION of Redmond, Wash., MAC OS available from APPLE, INC. of Cupertino, Calif., and LINUX available from LINUX ONLINE, INC. of Ogdensburg, N.Y.

In at least some embodiments, storage medium 104 comprises first process 108 and second process 112. For simplicity and ease of reference, one or more processes 112_{(1-N)} in process set 110 may be referred to as a process 112 indicating a member of the process set.

Storage medium 104 further comprises a process group management structure 114 which, in turn, comprises a process list 116, corresponding to the processes 112 of process set 110, and a signal set 118. In at least some embodiments, process list 116 comprises a reference to each process 112 in process set 110. In at least some embodiments, process list 116 comprises the processes in storage medium 104, e.g., processes 108 and 112.

In at least some embodiments, process group management structure 114 is related to a process set 110. In at least some embodiments, a process 108, 112 may be related to one or more process management structures. In at least some embodiments, process list 116 comprises a process group, i.e., a group of processes related, directly or indirectly, to a group leader process. In at least some embodiments, one or more processes 112 of process list 116 may comprise a same group leader process.

Signal set 118 comprises a list of signals to be delivered to processes 112 within process list 116, i.e., the signal set is a set of pending signals for delivery to a process group (a process group pending signal set). A signal is a form of inter-process communication. In some embodiments, a signal is an asynchronous notification transmitted to a process regarding an event occurrence. SIGHUP, SIGINT, and SIGKILL are particular signals which may be transmitted to a process, in at least some embodiments.

In at least some embodiments, given termination of a group leader process of a process group terminates execution, the group leader process transmits a signal, e.g., a hangup signal or SIGHUP, to the remaining processes in the process group. In some other embodiments, a process which is not a part of a process group may transmit a signal to processes in a process group.

In at least some embodiments, storage medium 104 comprises a process management structure corresponding to the number of process sets 110.

Operating system 106 comprises a signal daemon 120 for transmitting a signal, e.g., a signal from signal set 118, to one or more processes. In at least some embodiments, operating system 106 comprises more than one signal daemon. A daemon is a process or thread started by the operating system that executes in the background and does not have a controlling terminal.

In at least some embodiments, a process is able to transmit a signal to one or more processes in a process group using a signal daemon of the operating system instead of requiring the process to directly transmit the signal to the processes in the process group. In at least some embodiments, the process notifies the signal daemon to perform the delivery of the signal to the processes. An exemplary implementation performs such operations relatively fast and/or almost instantaneously, for example, regardless how many processes are in a group. An exemplary implementation avoids holding spinlocks or staying in an interrupt context for an excessive period of time.

In at least some embodiments, signal daemon 120 comprises one or more threads of execution to cause processor 102 to perform the particular functionality, i.e., handle requests to deliver a signal to a process group. The signal daemon threads in an example loop over each process in the process group and deliver signals to each process. An exemplary implementation proceeds in a threads context and avoids the problems of staying in an interrupt context as occurs during process transmission of signals to other processes. In at least some embodiments, signal daemon 120 operates in an asynchronous manner to deliver a signal to a process group.

Exemplary locks comprise one or more of spinlocks, non-spin lock, blocking locks, read/write locks, adaptive locks, mutexes, condition variables, and/or semaphores. An exemplary implementation uses a blocking lock for iterating over processes in process list 116 to deliver a signal from signal set 118. In at least some embodiments, a process group read-write lock may be used.

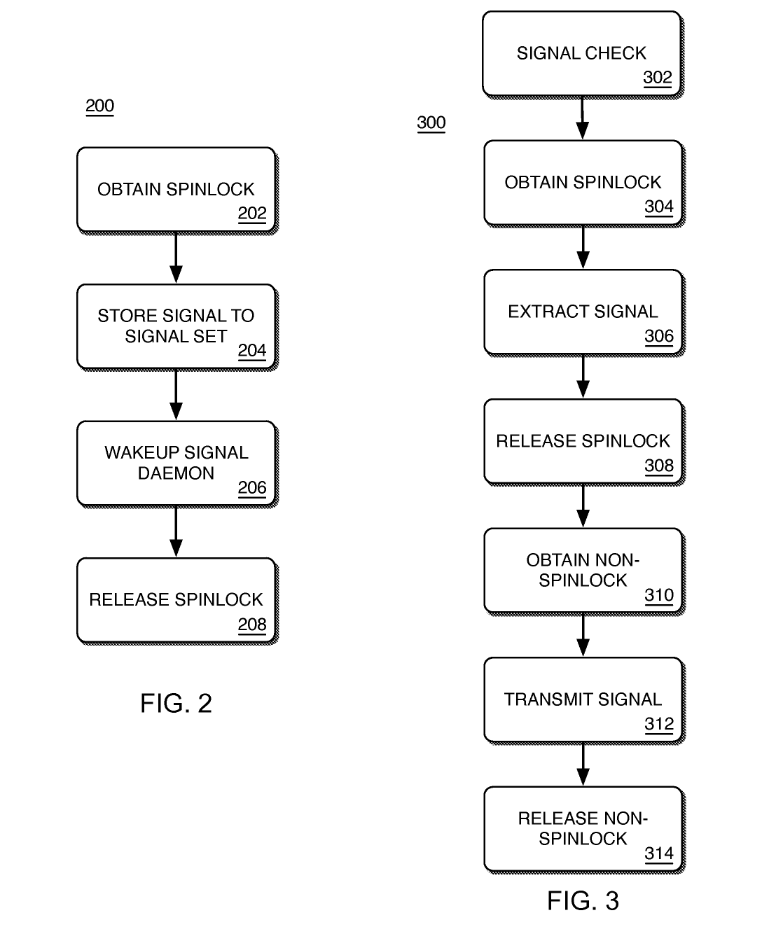

FIG. 2 depicts a high-level process flow diagram of execution of a process group signal set portion 200 of process 108 according to an embodiment. Portion 200 corresponds to process 108 transmitting a signal to processes 112 in process set 110, e.g., transmission of a SIGHUP signal from process 108 to process set 110 indicating termination of execution of process 108. The flow of control begins at obtain spinlock 202 functionality wherein process 108 requests a spinlock with respect to signal set 118. In at least some embodiments, process 108 requests a spinlock with respect to process list 116 and/or process group management structure 114. After process 108 obtains the requested spinlock, the flow proceeds to store signal 204 functionality.

During store signal 204, process 108 stores the signal to be transmitted to processes 112 in process set 110 to signal set 118. After storing the signal to signal set 118, the flow proceeds to wakeup signal daemon 206 functionality.

During wakeup signal daemon 206, process 108 transmits a wakeup signal to signal daemon 120 requesting the signal daemon to transmit the stored signal in signal set 118 to processes 112 in process list 116. In at least some embodiments, process 108 transmits a reference to process group management structure 114 to signal daemon 120 with the transmitted wakeup signal. In at least some embodiments, process 108 transmits a reference to the stored signal to be transmitted by signal daemon 120 with the transmitted wakeup signal. After transmitting the wakeup signal to signal daemon 120, the flow proceeds to release spinlock 208 functionality wherein process 108 releases the spinlock obtained in obtain spinlock 202.

In accordance with the above embodiment, transmission of the signal from process 108 to processes 112 is shifted from being performed in an interrupt-driven context by the process to an asynchronous mechanism using signal daemon 120. In this manner, signal daemon 120 may voluntarily yield processor 102 to perform other work loads.

FIG. 3 depicts a high-level process flow diagram of execution of a signal transmission portion 300 of signal daemon 120 according to an embodiment. Portion 300 corresponds to signal daemon 120 transmitting a signal from signal set 118 to processes 112 in process set 110. The flow of control begins at signal check 302 functionality wherein signal daemon 120 determines whether a signal in signal set 118 is awaiting delivery to processes 112 of process list 116. If the result of signal check 302 is positive (a signal is stored in signal set 118 for delivery to processes 112 in process list 116), the flow proceeds to obtain spinlock 304 functionality. If the result of signal check 302 is negative (a signal is not in signal set 118 for delivery), execution of portion 300 by signal daemon 120 terminates. In at least some embodiments, if the result of signal check 302 is negative, signal daemon 120 enters a sleep state pending receipt of a wakeup signal.

During obtain spinlock 304, signal daemon 120 requests a spinlock with respect to signal set 118. In at least some embodiments, signal daemon 120 requests a spinlock with respect to process list 116 and/or process group management structure 114. After signal daemon 120 obtains the requested spinlock, the flow proceeds to extract signal 306 functionality.

During extract signal 306, signal daemon 120 reads the signal to be transmitted to processes 112 in process set 110 from signal set 118. In at least some embodiments, signal check 302 may be integrated and performed as part of extract signal 306. After reading the signal from signal set 118, the flow proceeds to release spinlock 308 functionality.

During release spinlock 308, signal daemon 120 releases the spinlock obtained during obtain spinlock 304. The flow proceeds to obtain non-spinlock 310 functionality.

During obtain non-spinlock 310, signal daemon requests a non-spinlock with respect to process list 116, e.g., signal daemon requests a blocking lock on process list 116 in order to prevent modification of the process list by non-signal daemon functionality during subsequent operations. In at least some embodiments, signal daemon 120 requests a non-spinlock with respect to process list 116 and/or process group management structure 114. After signal daemon 120 obtains the requested spinlock, the flow proceeds to transmit signal 312 functionality.

During transmit signal 312, signal daemon 120 iterates over process list 116 and transmits the read signal from signal set 118 to the processes 112. In at least some embodiments, signal daemon 120 comprises one or more threads of execution which may execute to transmit the read signal to one or more processes 112 from process list 116. After signal daemon 120 transmits the read signal to processes 112 of process list 116, the flow of control proceeds to release non-spinlock 314 functionality.

During release non-spinlock 314, signal daemon 120 releases the non-spinlock obtained during obtain non-spinlock 310. After release of the non-spinlock by signal daemon 120, execution of portion 300 by signal daemon 120 terminates. In at least some embodiments, if the result of signal check 302 is negative, signal daemon 120 enters a sleep state pending receipt of a wakeup signal.

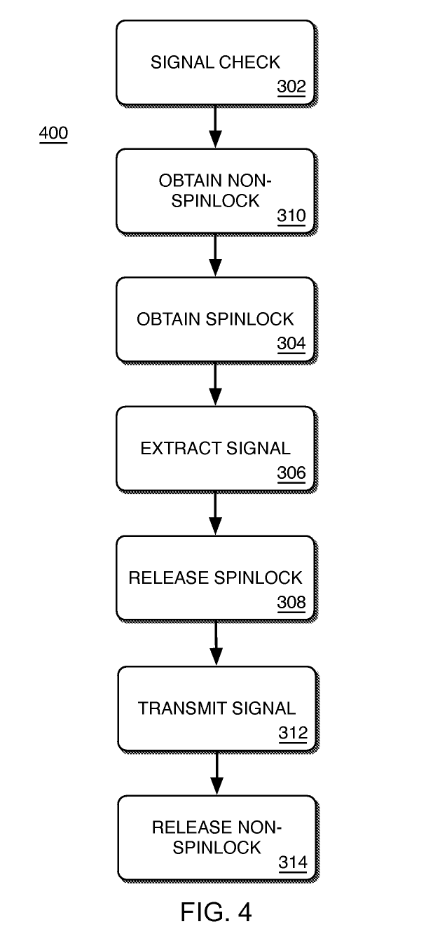

FIG. 4 depicts a high-level process flow diagram of execution of a signal transmission portion 400 of signal daemon 120 according to another embodiment wherein obtain non-spinlock 310 functionality is performed earlier in the process flow. Individual functionality, i.e., 302-314, is performed substantially similar to the functionality of portion 300 and differs in the order.

The flow of control begins at signal check 302 wherein signal daemon 120 determines whether a signal in signal set 118 is awaiting delivery to processes 112 of process list 116. If the result of signal check 302 is positive (a signal is stored in signal set 118 for delivery to processes 112 in process list 116), the flow proceeds to obtain non-spinlock 310 functionality. If the result of signal check 302 is negative (a signal is not in signal set 118 for delivery), execution of portion 300 by signal daemon 120 terminates. In at least some embodiments, if the result of signal check 302 is negative, signal daemon 120 enters a sleep state pending receipt of a wakeup signal.

During obtain non-spinlock 310, signal daemon requests a non-spinlock with respect to process list 116, e.g., signal daemon requests a blocking lock on process list 116 in order to prevent modification of the process list by non-signal daemon functionality during subsequent operations. In at least some embodiments, signal daemon 120 requests a non-spinlock with respect to process list 116 and/or process group management structure 114. After signal daemon 120 obtains the requested spinlock, the flow proceeds to obtain spinlock 304 functionality.

During obtain spinlock 304, signal daemon 120 requests a spinlock with respect to signal set 118. In at least some embodiments, signal daemon 120 requests a spinlock with respect to process list 116 and/or process group management structure 114. After signal daemon 120 obtains the requested spinlock, the flow proceeds to extract signal 306 functionality.

During extract signal 306, signal daemon 120 reads the signal to be transmitted to processes 112 in process set 110 from signal set 118. In at least some embodiments, signal check 302 may be integrated and performed as part of extract signal 306. After reading the signal from signal set 118, the flow proceeds to release spinlock 308 functionality.

During release spinlock 308, signal daemon 120 releases the spinlock obtained during obtain spinlock 304. The flow proceeds to transmit signal 312 functionality.

During transmit signal 312, signal daemon 120 iterates over process list 116 and transmits the read signal from signal set 118 to the processes 112. In at least some embodiments, signal daemon 120 comprises one or more threads of execution which may execute to transmit the read signal to one or more processes 112 from process list 116. After signal daemon 120 transmits the read signal to processes 112 of process list 116, the flow of control proceeds to release non-spinlock 314 functionality.

During release non-spinlock 314, signal daemon 120 releases the non-spinlock obtained during obtain non-spinlock 310. After release of the non-spinlock by signal daemon 120, execution of portion 300 by signal daemon 120 terminates. In at least some embodiments, if the result of signal check 302 is negative, signal daemon 120 enters a sleep state pending receipt of a wakeup signal.

In at least some embodiments, computer 100 comprises a plurality of components such as one or more of electronic components, mechanical components, hardware components, and/or computer software components. A number of such components may be combined or divided in an embodiment. In at least some embodiments, one or more features described herein in connection with one or more components and/or one or more parts thereof are applicable and/or extendible analogously to one or more other instances of the particular component and/or other components in the computer system 100.

In at least some embodiments, apparatus 100 comprises and/or selectively communicatively couples with one or more computer-readable signal-bearing media. A computer-readable signal-bearing medium in one example stores software, firmware and/or assembly language for performing one or more portions of one or more implementations. An example of a computer-readable signal-bearing medium for an implementation of the apparatus 100 comprises storage medium 104 of the computer. In at least some embodiments, computer-readable signal-bearing medium comprises one or more of a magnetic, an electrical, an optical, a biological, and/or an atomic data storage medium. For example, an implementation of the computer-readable signal-bearing medium comprises floppy disks, magnetic tapes, CD-ROMs, DVD-ROMs, hard disk drives, and/or electronic memory.

Although one or more embodiments have been depicted and described in detail herein, it will be apparent to those skilled in the relevant art that various modifications, additions, substitutions, and the like may be made without departing from the spirit of the disclosed embodiments and these are therefore considered to be within the scope of the embodiments as defined in the following claims.

In at least some embodiments, processes 112 may perform functionality similar to signal check 302 performed by signal daemon 120. Accordingly, a process 112 performing a process signal check may determine with reference to process group management structure 114 whether a stored signal in signal set 118 is to be delivered to the particular process. In at least some embodiments, the particular process 112 may determine whether a signal is to be delivered to the particular process and/or a particular process group 110 of which the particular process 112 is a member. In at least some embodiments, one or more threads comprising a particular process 112 may perform the signal check on a thread basis to determine whether a signal is to be delivered to the particular thread. If a signal is determined to be pending for delivery to the particular process 112 (and similarly for a particular thread), the particular process may receive the signal directly (without waiting on delivery from signal daemon 120) and process the signal.

In at least some embodiments, process group management structure 114 may comprise one or more signal counters in order to respectively track the number of requests for delivering a signal to a process group and number of times a thread has reacted to a signal pending in signal set 118 in the signal checking path.

What is claimed is:

1. A method of handling a signal for delivery to a process in a process group, comprising:
obtaining a lock on at least a portion of a process management structure related to a process group;
storing a signal to the portion of the process management structure on which a lock has been obtained, wherein the signal is to be delivered to one or more processes of the process group, wherein the process management structure is managed by an operating system;
transmitting a wakeup signal to a signal daemon; and
releasing the obtained lock.

2. The method of claim 1, wherein the obtaining the lock comprises:
obtaining a lock for a signal set of the process management structure; and
wherein the storing the signal comprises:
storing the signal to the signal set of the process management structure.

3. The method of claim 1, wherein the transmitting the wakeup signal comprises:
transmitting a wakeup signal comprising a reference to the process management structure.

4. The method of claim 1, further comprising:
transmitting, by the signal daemon, the stored signal to one or more processes of a process list of the process management structure.

5. The method of claim 4, wherein the transmitting the stored signal comprises:
obtaining a lock on at least a portion of the process management structure related to the stored signal;
reading the stored signal from the process management structure;
transmitting the stored signal to a process of the process list.

6. The method of claim 5, further comprising:
repeating the transmitting the stored signal to a process of the process list for the remaining processes of the process list.

7. The method of claim 5, further comprising releasing the obtained lock on at least the portion of the process management structure related to the stored signal.

8. The method of claim 5, wherein the transmitting the stored signal to a process of the process list comprises:
obtaining a lock on the process list.

9. The method of claim 8, further comprising releasing the obtained lock on the process list.

10. The method of claim 4, wherein the transmitting the stored signal is performed in response to receipt of the wakeup signal by the signal daemon.

11. A method of delivering a signal to a process in a process group, comprising:
obtaining a signal from a process management structure related to a process group, wherein the process management structure is managed by an operating system;
obtaining a lock on a process list of the process management structure specifying processes to which the signal is to be delivered;
transmitting the signal to a process specified in the process list; and
releasing the lock on the process list.

12. The method of claim 11, further comprising:
determining existence of the signal to be delivered to a process prior to the obtaining the signal.

13. The method of claim 11, wherein the obtaining the signal is performed responsive to receipt of a wakeup signal.

14. The method of claim 11, further comprising:
repeating the transmitting the signal for the remaining processes specified in the process list.

15. The method of claim 11, wherein the obtaining a lock comprises obtaining a blocking lock.

16. An apparatus for handling a signal for delivery to a process in a process group, comprising:
a first process;
a process group comprising one or more second processes;
a signal daemon; and
a process management structure related to the process group, wherein the process management structure is managed by an operating system;
wherein the first process is arranged to store a signal in the process management structure to be delivered to the one or more second processes in the process group;
wherein the signal daemon is arranged to read the signal from the process management structure and deliver the signal to the one or more second processes.

17. The apparatus of claim 16, wherein the process management structure comprises a signal set;
wherein the first process is arranged to store the signal in the signal set;
wherein the signal daemon is arranged to read the signal from the signal set.

18. The apparatus of claim 16, wherein the first process, in an interrupt context, is arranged to store the signal in the signal set;
wherein the signal daemon, in a thread context, is arranged to read the signal from the signal set;
wherein the signal daemon, in a thread context, is arranged to transmit the signal to the one or more second processes.

19. The apparatus of claim 16, wherein the first process is arranged to obtain a lock on the signal set in order to store the signal in the signal set;
wherein the signal daemon is arranged to obtain the lock on the signal set in order to obtain the signal from the signal set.

20. A computer-readable medium storing instructions which, when executed by a processor, cause the processor to obtain a lock on at least a portion of a process management structure related to a process group; store a signal to the portion of the process management structure on which a lock has been obtained, wherein the signal is to be delivered to one or more processes of the process group, wherein the process management structure is managed by an operating system; transmit a wakeup signal to a signal daemon; and release the obtained lock.

21. A method of communicating a signal from a sender process to plural receiving processes in a process group, comprising:
responsive to a system call by the sender process:
acquiring a first lock on a management data structure corresponding to the process group;
modifying the management data structure to indicate the signal; and
in a signal delivery daemon:
acquiring the first lock;
reading information about the signal from the management data structure;
acquiring a second lock on a process list corresponding to the plural receiving processes; and
delivering the signal to each of the plural receiving processes on the process list.

22. The method of claim 21, wherein responsive to a system call by the sender process further comprises:
releasing the first lock; and
returning to the sender process after modifying the management data structure.

23. The method of claim 21, wherein in a signal delivery daemon further comprises:
releasing the first lock prior to acquiring the second lock.

24. The method of claim 21, wherein in a signal delivery daemon further comprises:
releasing the second lock on the process list after acquiring the second lock.

25. The method of claim 21, further comprising:
waking the signal delivery daemon from a sleep state prior to returning to the sender process.

26. The method of claim 21, wherein:
acquiring a first lock comprises acquiring a spinlock.

27. The method of claim 26, wherein:
acquiring a second lock comprises acquiring a blocking lock.

28. The method of claim 21, wherein:
acquiring a second lock comprises acquiring a blocking lock.
